(19) United States
(12) Patent Application Publication
(10) Pub. No.: US 2009/0053938 A1
(43) Pub. Date: Feb. 26, 2009

(54) PLUG-TYPE CONNECTOR FOR TELECOMMUNICATIONS AND DATA ENGINEERING

(75) Inventor: Hartmut Borchardt, Berlin (DE)

Correspondence Address: MERCHANT & GOULD PC, P.O. BOX 2903, MINNEAPOLIS, MN, 55402-0903, US

(73) Assignee: ADC GmbH, Berlin (DE)

(21) Appl. No.: 12/282,627

(22) PCT Filed: Feb. 2, 2007
(86) PCT No.: PCT/EP2007/000950

§ 371 Date: Sep. 11, 2008

(30) Foreign Application Priority Data
Mar. 18, 2006 (DE) 10 2006 012 518.5

(51) Int. Cl. H01R 24/00

(52) U.S. Cl. 439/676

(57) ABSTRACT

The invention relates to a plug-in connector (1) for telecommunications and data technology for the purpose of connecting a symmetrical data cable, the plug-in connector (1) comprising an electrically insulating plug-in connector housing (2) as well as first contacts (8) and second contacts (7), contact being made with a plurality of core pairs of a symmetrical data cable by means of the first contacts, and it being possible for an electrical contact to be produced with the contacts of a complementary plug-in connector by means of the second contacts, in each case two first contacts being assigned to a core pair, and a second contact being assigned to each first contact, the first contacts being DC-connected to their associated second contacts, in each case one common-mode filter arrangement being assigned to all of the core pairs.

The invention relates to a plug-in connector for telecommunications and data technology in accordance with the preamble of claim 1.

Such plug-in connectors are, for example, RJ45 sockets or plugs, such a generic RJ45 socket being described in WO 02/15339.

Furthermore, DE 298 19 314 U1 has disclosed a socket-type plug-in connector having a dielectric plug-in connector housing and contacts arranged in the plug-in connector housing for the purpose of producing a connection with the contacts of an associated plug-in connector which has been inserted into an insertion opening in the plug-in connector housing, and having external connection contacts for the purpose of producing an electrical connection with the socket-type plug-in connector, having an arrangement for the purpose of DC-decoupling the contacts for the associated plug-in connector from the external connection contacts and having a filter device, an element being provided which can be inserted essentially completely into the plug-in connector housing and holds both the contacts for the associated plug-in connector and the external connection contacts, and in which both the arrangement for the DC-decoupling and the filter device are arranged. The arrangement for the DC-decoupling and the filter device comprise inductances which are formed by coils having a ferrite ring core, whose center axes are aligned in each case parallel to one another. Transformers for the DC-decoupling act as a bandpass filter, which is disadvantageous in particular in the case of broadband transmissions in accordance with CAT6 and 10 gigabit/s Ethernet applications.

In the case of CAT6 or 10 gigabit/s Ethernet applications, in addition to the known crosstalk effects within a plug-in connector, such as NEXT (near end crosstalk) and FEXT (far end crosstalk), there is an increased influence of the so-called ANEXT (alien near end crosstalk) or AFEXT (alien far end crosstalk) in adjacent plug-in connectors. The influence of the ANEXT or AFEXT increases severely at higher signal transmission rates. This AXT (alien crosstalk) comprises the direct AXT between the plug-in connectors and the indirect AXT via the differential mode to common mode conversion of the plug-in connector, the common-mode coupling between the connected cables and the common mode to differential mode conversion in the plug-in connector which is subjected to the interference.

The invention is therefore based on the technical problem of providing a plug-in connector for telecommunications and data technology, by means of which the influence of the AXT is reduced at high transmission rates of CAT6 or 10 gigabit/s Ethernet.

The solution to the technical problem results from the subject matter having the features of claim 1. Further advantageous refinements of the invention are described in the dependent claims.

In this regard, in each case one common-mode filter arrangement is assigned to all of the core pairs. An interfering common-mode signal is thereby attenuated in pairs, with the result that this attenuated common-mode component does not lead to AXT in an adjacent plug-in connector. At the same time, the common-mode filter arrangement also attenuates injected common-mode signals from other plug-in connectors.

In one preferred embodiment, the common-mode filter arrangement is in the form of a common-mode inductor, which is arranged on a printed circuit board for the first and second contacts, the common-mode inductor preferably being in the form of an SMD component, which allows for a compact design. The common-mode inductor is in this case preferably electrically connected between the first and second contacts.

As an alternative or in addition, the common-mode filter arrangement can be in the form of a ferrite sleeve, a dedicated ferrite sleeve being assigned to each core pair, whereas an individual ferrite sleeve would have virtually no effect for the entire cable. The reason for this is the fact that the common-mode signals on the different core pairs do not necessarily have the same direction. The common-mode interference therefore needs to be reduced separately for each core pair.

Various embodiments are now possible for connecting the ferrite sleeve to the plug-in connector or the plug-in connector housing.

In one embodiment, the ferrite sleeves are in the form of a separate component and are fixed, for example latched or adhesively bonded, to the plug-in connector housing. In addition to the actual plug-in connector housing, the ferrite sleeves can also be arranged on a cable manager of the plug-in connector.

In one alternative embodiment, the plug-in connector housing and/or a retainer and/or a cable manager is made at least partially from a ferrite material or contains ferrite material. It is thus possible, for example, for a cable manager to be made completely from a ferrite material, the core pairs then being passed through said cable manager in their respectively associated segment. As an alternative, the ferrite sleeves can be encapsulated by injection molding in the plug-in connector housing. It is also possible to admix ferrite powder to the plastic injection molding material.

A common-mode filter arrangement preferably takes place in the case of a plug-in connection both on the plug side and on the socket side, but the respective design of the common-mode filter arrangement may be different.

The invention will be explained in more detail below with reference to a preferred exemplary embodiment. In the figures:

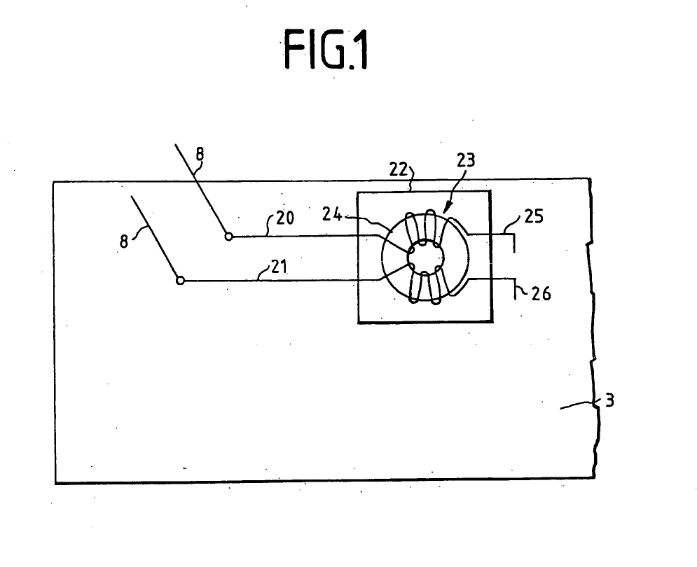

FIG. 1 shows a schematic illustration of a common-mode inductor on a printed circuit board for the first and second contacts, and

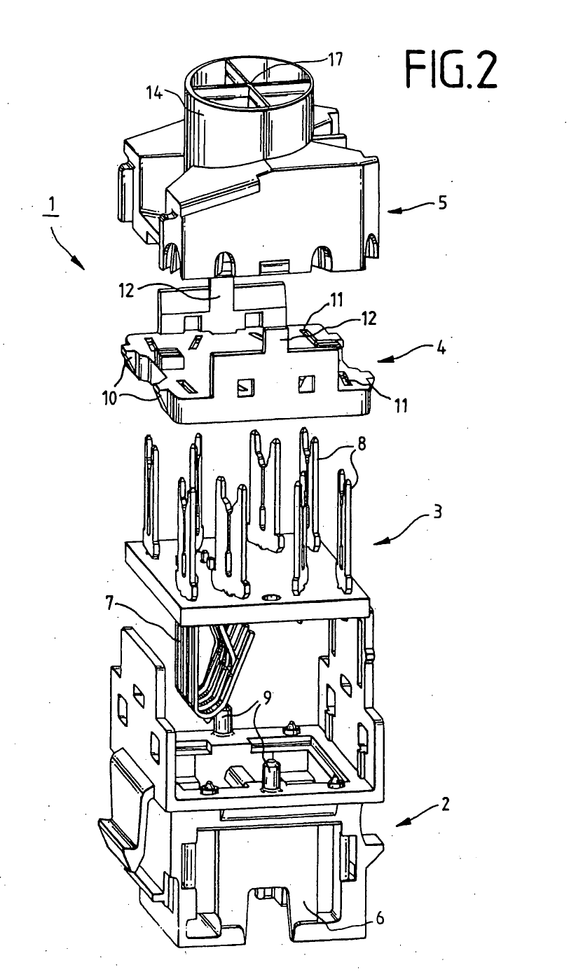

FIG. 2 shows an exploded illustration of a plug-in connector (prior art).

FIG. 2 shows an exploded illustration of a plug-in connector 1. The plug-in connector 1 comprises a plug-in connector housing 2, a printed circuit board 3, a retainer 4 and a cable manager 5. In the example illustrated, the plug-in connector housing 2 is in the form of a socket housing having various latching and insertion means. The plug-in connector housing 2 is formed with a shielding plate 6 on the side faces. The printed circuit board 3 is populated with a set of second contacts 7 on its front and with a set of first contacts 8 on its reverse, said first contacts 8 being in the form of insulation displacement contacts. In each case one contact 7 is connected to a contact 8. The printed circuit board 3 is then inserted into the plug-in connector housing 2. In the process, cylinder pins 9 of the plug-in connector housing 2 pass through holes in the printed circuit board 3, with the result that the plug-in connector housing 2 and the printed circuit board 3 are adjusted and fixed with respect to one another. The contacts 7 in the form of RF contacts then protrude into an opening which is accessible from the front of the plug-in connector housing. Then, the retainer 4 is pushed over the contacts 8 of the second set and latched to the plug-in connector housing 2. For this purpose, the retainer 4 is formed with latching tabs 10 on the end side and has continuous openings 11 for the insulation displacement contacts 8. Furthermore, the retainer 4 is formed with two latching hooks 12, which serve the purpose of latching with a cable manager 5. The cable manager 5 is essentially square and has an opening in the center, around which a cylindrical attachment 14 is arranged. The opening extends from the rear continuously to the front, a guide cross 17 being arranged in the opening and dividing the opening into four segments. In this case, in each case an associated core pair of a data cable is guided in one segment. As regards the further design of the plug-in connector, express reference is hereby made to WO 02/15339.

FIG. 1 now shows a schematic illustration of a first embodiment of the common-mode filter arrangement for a plug-in connector shown in FIG. 2. Two associated insulation displacement contacts 8 are illustrated on the printed circuit board 3, by means of which contacts 8 contact is made with the cores of a core pair. The two insulation displacement contacts 8 are electrically connected to an SMD component 22 via in each case one conductor track 20, 21, said SMD component 22 comprising a common-mode inductor 23 having a ferrite ring 24. The SMD element 22 is connected to the associated RF contacts 7 on the other side of the printed circuit board 3 via conductor tracks 25, 26 and through-platings (not illustrated). As a result, the common-mode signal on the core pair is reduced in pairs, with the result that this core pair represents a lesser interference source for adjacent plug-in connectors. In the exemplary embodiment illustrated, the common-mode inductor 23 for only one core pair is illustrated. It goes without saying that, in the case of an RJ45 socket as shown in FIG. 2, four common-mode inductors 23 are used for the four core pairs. Alternatively, the plug-in connector housing 2 or the retainer 4 and/or the cable manager 5 may also be made from ferrite material or contain ferrite material.

### LIST OF REFERENCES

1 Plug-in connector

2 Plug-in connector housing

3 Printed circuit board

4 Retainer

5 Cable manager

6 Shielding plate

7 RF contacts

8 Insulation displacement contacts

9 Cylinder pins

10 Latching tabs

11 Openings

12 Latching hooks

14 Cylindrical attachment

17 Guide cross

20 Conductor track

21 Conductor track

22 SMD component

23 Common-mode inductor

24 Ferrite ring

25 Conductor track

26 Conductor track

1. A plug-in connector for telecommunications and data technology for the purpose of connecting a symmetrical data cable, the plug-in connector comprising an electrically insulating plug-in connector housing as well as first contacts and second contacts, contact being made with a plurality of core pairs of a symmetrical data cable by means of the first contacts, and it being possible for an electrical contact to be produced with the contacts of a complementary plug-in connector by means of the second contacts, in each case two first contacts being assigned to a core pair, and a second contact being assigned to each first contact, the first contacts being DC-connected to their associated second contacts, wherein
in each case one common-mode filter arrangement is assigned to all of the core pairs.

2. The plug-in connector as claimed in claim 1, wherein the first and second contacts are connected via a printed circuit board, the common-mode filter arrangement being in the form of a common-mode inductor, which is arranged on the printed circuit board.

3. The plug-in connector as claimed in claim 2, wherein the common-mode inductor is in the form of an SMD component.

4. The plug-in connector as claimed in claim 1, wherein the common-mode filter arrangement is in the form of a ferrite sleeve.

5. The plug-in connector as claimed in claim 4, wherein the ferrite sleeves are fixed as a separate component to the plug-in connector housing.

6. The plug-in connector as claimed in claim 4, wherein the plug-in connector housing is made at least partially from a ferrite material or contains ferrite material.
